(19) United States
(12) Patent Application Publication
(10) Pub. No.: US 2009/0103457 A1
(43) Pub. Date: Apr. 23, 2009

(54) Method and apparatus for providing notification of an attempted communication

(76) Inventor: Louis Mamakos, Lawrenceville, NJ (US)

Correspondence Address: VONAGE, 23 MAIN STREET, HOLMDEL, NJ, 07733, US

(21) Appl. No.: 12/283,516

(22) Filed: Sep. 12, 2008

Related U.S. Application Data
(60) Provisional application No. 60/993,752, filed on Sep. 14, 2007.

(51) Int. Cl. H04L 12/16; H04L 12/66

(52) U.S. Cl. 370/259; 370/352

(57) ABSTRACT

Method and system for providing notification of attempted voice communication between a calling party and a called party in a voice communication system includes the called party receiving a voice communication attempt, sending notification of the voice communication attempt to a registration device associated with the called party, forwarding notification from the registration device to a terminating point associated with the called party and storing notification at the terminating point. Notification occurs as a result of a called party calling feature diverting the voice communication attempt. Notification is generated and sent by an inbound voice communication processor of a VoIP communication system. The registration device is an outbound/registration communication processor of a VoIP communication system. A system for providing notification of attempted voice communication between a calling party and a called party includes, among other components, an outbound communication processor adapted for receiving notification of an attempted voice communication.

The application claims the benefit of U.S. Provisional Application No. 60/993,752, filed Sep. 14, 2007.

### FIELD OF THE INVENTION

The invention is related to the field of telecommunication devices and services and more specifically, the invention is directed to a method and apparatus (system) for executing various features of a telecommunication service and notifying a user of the occurrence of such activity.

### BACKGROUND OF THE INVENTION

Voice over Internet Protocol (VoIP) is a recent technological development in the field of telecommunications that is utilized to transmit voice conversations over a data network using the Internet Protocol (IP). Entities (e.g., businesses or individuals) implement VoIP by purchasing and installing the necessary equipment (e.g., one or more Customer Premise Equipment (CPE) devices) to access a VoIP service provider and activating this telecommunication service. Since VoIP is a relatively new technology in terms of its commercial penetration, it has yet to completely supplant the existing and traditional telecommunications system more commonly referred to as the Public Switched Telephone Network (PSTN) or Plain Old Telephone Service (POTS). Accordingly, there is a great deal of existing PSTN equipment that entities are reluctant to completely abandon for economic and strategic reasons. To further complicate matters, VoIP-based CPE devices and existing PSTN-based devices are not compatible. Therefore, VoIP service providers desire to provide their customers with at least similar or identical functionality and features to those found in the PSTN environment. Additionally, any opportunity to provide improvements not found in the PSTN environment are greatly desirable so as to enhance the VoIP customer's experience.

One such experience revolves around knowing the status of a voice communication (or phone call) in situations where the call is not delivered to the intended user (i.e., via the user's primary telephone number). For example, two special call handling features known in the art are “Do Not Disturb” (DnD) and “Call Forwarding” (CF). Such call handling features reroute an incoming call to a secondary destination such as a voice mailbox or a forwarding phone number. As such, it is possible that the primary user telephone number (i.e., the number to which the call was originally intended to be delivered to) may never have the call delivered to it or otherwise generate an alert to the user of such communication attempt. It is proposed that it may be useful to know if such call handling features were actually executed so that the user is more fully aware of the status of any and all attempted communications to the primary user number regardless of how they were finally handled.

Therefore, there is a need in the art for a method and apparatus for providing notification of the status of attempted communications.

### SUMMARY OF THE INVENTION

The disadvantages associated with the prior art are overcome by a method and system for providing notification of an attempted voice communication between a calling party and a called party in a voice communication system. The method includes the steps of having a called party receive a voice communication attempt, sending a notification of the voice communication attempt to a registration device associated with the called party, forwarding the notification from the registration device to a terminating point associated with the called party and storing the notification at the terminating point associated with the called party. The method may be practiced by a computer readable medium storing a software program that, when executed by a computer, causes the computer to perform an operation of providing notification of an attempted voice communication between a calling party and a called party in a voice communication system as described above.

The notification occurs as a result of a called party calling feature diverting the voice communication attempt and such calling feature is selected from the group consisting of Do Not Disturb and Call Forwarding. The notification is generated by and sent from a device that is adapted for executing steps to establish a link between a calling party and the called party such as an inbound voice communication processor of a VoIP communication system. In one embodiment of the invention, the registration device is an outbound/registration communication processor of a VoIP communication system. The notification may be a Session Initiation Protocol (SIP) message and in one embodiment of the invention is a SIP NOTIFY message. Such SIP NOTIFY message contains information about the attempted voice communication.

The terminating point may be the called party's logical SIP endpoint. The step of storing occurs at a termination point selected from the group consisting of an Analog Telephone Adapter, an IP phone and Local Access Network (LAN) device associated with the called party. In one embodiment of the invention, more than one notification can be stored at the terminating point and such notifications can be reviewing in a log. The one or more stored notifications can be reviewed by recalling them from a communication device or reviewing them via a web-based interface associated with a called party's communication service account. In an alternate embodiment of the invention, the notifications are queued at a location that is not the terminating point when the terminating point is temporarily unavailable.

A system for providing notification of an attempted voice communication between a calling party and a called party in accordance with the subject invention includes caller communication equipment, an inbound communication processor connected to the caller communication equipment, one or more databases connected to the inbound communication processor, one or more subsystems adapted for calling feature processing connected to the inbound communication processor, an outbound communication processor connected to the inbound communication processor adapted for receiving notification of an attempted voice communication and called party communication equipment connected to the outbound communication processor. The outbound communication processor serves as an intermediate point for attempted voice communication notifications.

The called party communication equipment includes an Analog Telephone Adapter, an IP phone and Local Access Network (LAN) device associated with the called party where more than one notification can be stored at the called party communication equipment.

### BRIEF DESCRIPTION OF THE FIGURES

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a series of method steps for performing notification of an attempted voice communication in accordance with the subject invention;

FIG. 2 depicts a series of method steps that details the execution of a DnD feature associated with voice communication processing in accordance with the subject invention;

FIG. 3 depicts a system for performing notification of an attempted voice communication in accordance with the subject invention; and

FIG. 4 depicts a schematic diagram of a controller that may be used to practice the method of the present invention.

To facilitate understanding, identical reference numerals have been used, where possible, to designate identical elements that are common to the figures.

### DETAILED DESCRIPTION

To achieve the desired objectives, the subject invention provides for a method of and apparatus for providing notification of an attempted voice communication between a calling party (Party A) and a called party (Party B). In a preferred embodiment of the invention, the attempted voice communication is a telephone call originated from a VoIP device, linked to VoIP equipment and network(s) placed from a telephone number associated with Party A to a primary telephone number associated with Party B. Additionally, the apparatus that accomplishes this notification task is, in a preferred embodiment of the invention, one or more components of a VoIP communication system. Such communication system is, by way of example, part of any public or private data network (or combination thereof) constructed for (in part) and adapted to convert analog voice signals (e.g., generated by a human utterance) to a digitized and packetized format according to known and understood protocols (such as but not limited to Transmission Control Protocol/Internet Protocol (TCP/IP)) for transmission from an originating point (Party A) to one or more terminating points (Party B and/or C, D and the like). In a preferred embodiment of the invention, the data network is an IP-based network such as (but not limited to) the Internet having VoIP specific and related components connected thereto as explained in greater detail below. Alternately, the telephone call from Party A may originate from a POTS device, linked to the PSTN and eventually linked to VoIP equipment and network(s) to reach Party B.

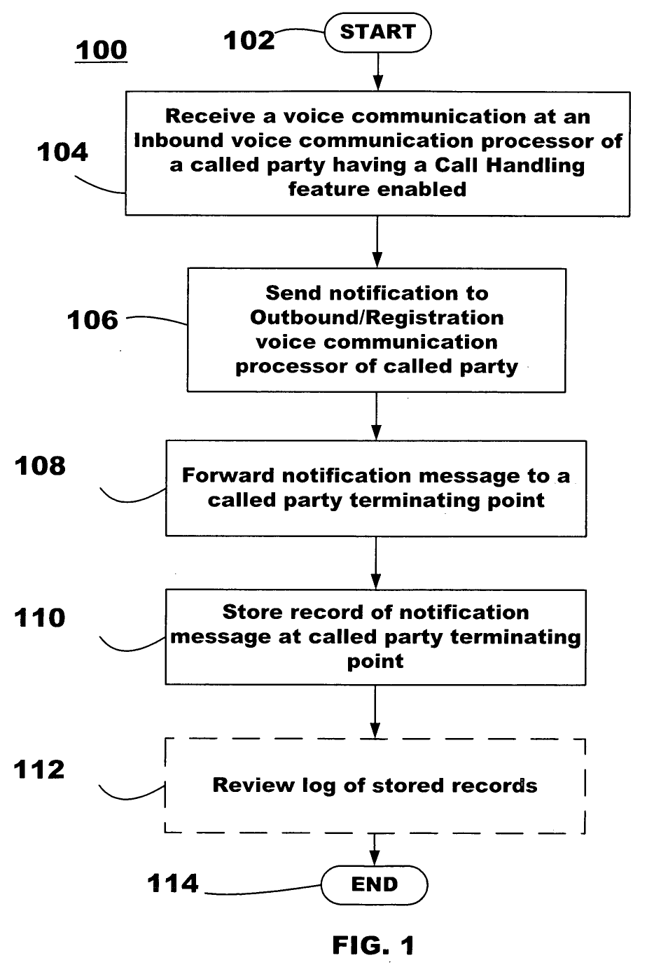

FIG. 1 depicts a series of method steps 100 for performing such notification operations in accordance with the subject invention. To simplify this portion of the disclosure, it is assumed that Party B has previously enabled a call feature associated with his/her telephone number. Such call feature, in one embodiment, is DnD (as part of his existing telecommunication preferences) and any attempted voice communications (i.e., VoIP calls) must be processed according to DnD policies and procedures. Such conditions will be described in greater detail below. The notification method 100 starts at step 102 and proceeds to step 104 where a voice communication is received at an Inbound voice communication processor of the called party. The Inbound voice communication processor executes the necessary steps to assist in establishing a link between Party A and Party B. In one embodiment, such action is accomplished according to Session Initiation Protocol (SIP). The details and functionality of SIP can be found in the Internet Engineering Task Force (IETF) Request for Comments Paper No. 3261 herein incorporated in its entirety by reference.

At step 106, a notification message is sent from the Inbound voice communication processor to a Registration/Outbound voice communication processor of Party B via the public/private data network. The notification message is created as a consequence of the flow of the voice communication being diverted elsewhere (e.g., as a result of the DnD feature being enabled). While the Registration/Outbound voice communication processor does perform other functions (described in greater detail below), for the purposes of the subject invention, the Registration/Outbound voice communication processor receives information about an incoming voice communication in addition to performing routine registration and other outgoing voice communication tasks. In a preferred embodiment of the invention, the notification message is a SIP NOTIFY message. The SIP NOTIFY message contains information about the now attempted call from Party A that was not delivered because of Party B's DnD preferences at the time the call was placed. The NOTIFY message is transmitted and received with normal and expected transport delays (similar to a SIP INVITE message). That is, it is not necessary to store or otherwise delay such message to the Registration/Outbound processor.

At step 108, the notification message is forwarded to a called party terminating point. In the embodiment where SIP signaling is used, the message's final destination is Party B's logical SIP endpoint (though not necessarily the phone or other equipment used by Party B to actually speak to and hear other parties). In a first embodiment of the invention, the notification message is forwarded to Party B's Analog Telephone Adapter (ATA) as explained below with respect to a system in accordance with the subject invention. Regardless of the specific equipment and embodiment described, the notification message may not cause Party B's telephone to ring or otherwise create an alert as to the attempted call by Party A. In an alternate embodiment of the invention, the notification message(s) are queued at a location that is not the terminating point when the terminating point is temporarily unavailable (i.e., the ATA has temporarily been removed or relocated, or a wireless handset is temporarily turned off or disabled by low battery condition or the like). Examples of locations that are not the terminating point where the queuing can take place are selected from the group consisting of the Inbound voice communication processor, the Registration/Outbound voice communication processor and a generic system processor that is tasked with awaiting presence or registration information associated with Party B.

At step 110, a record of the notification message is stored. More specifically and in the SIP signaling embodiment, the NOTIFY message is like other types of SIP messages in that it is transitory in nature and once arriving at its destination, will cease to exist. As such, it is important that a record of the NOTIFY message be created to achieve the desired effect and solve the discussed problem. The storing operation is performed at Party B's logical SIP endpoint and in one embodiment, the record is created and stored in a Party B's communication device. The communication device is selected from the group consisting of an ATA, an IP phone and a LAN device on the same local network as the communication device. The record indicates that a call was attempted to Party B's number, but an actual voice session between Party A and Party B did not occur. There can be more than one record created and saved by means of step 110 as additional calls are placed to Party B when Party B's DnD feature is still enabled and method 100 is repeated. As such a log of a plurality of records exists in the communication device. The log is used, in part, to create a history of attempted calls. This attempted call history can be made part of other call information such as received (inbound) calls, placed (outbound) calls and the like and may also have caller ID information appended to the log information. Additionally and in an alternate embodiment of the invention, the notification message further results in the creation of a cueing signal on the device associated with the termination point. The cueing signal acts as an alert that a new notification message has occurred (i.e., a call was immediately prior diverted or not delivered in accordance with the subject invention). This action serves as a reminder function to the VoIP account holder for conditions selected from the group consisting of being reminded that the notification method and apparatus is active and that prompt examination of the log is recommended. The cueing signal is selected from the group consisting of a visual cue (i.e., steady or flashing light, display screen or the like) and an aural cue (i.e., intermittent or continuous tone) generated by the device associated with the termination point or otherwise operated by the VoIP account holder. The cueing signal may optionally be accompanied by a physical cue such as but not limited to a vibratory motion imparted by the device as is known in the art.

The log of NOTIFY message records may optionally be reviewed by Party B at step 112. That is, step 112 need not be executed at every occurrence of method 100 in order to practice the invention. For example, Party B can access the log by selecting an appropriate option on his communication device (i.e., IP phone) and scrolling through the log on an IP phone display. Alternately, the log can be accessed via a web-based interface that permits Party B to review information regarding his communication service account. While any number of records can be stored and viewed based on the memory size and allocation in the communication device, preferably the last ten (10) records are stored in a queue-type (last in, first out) listing. After step 112, the method 100 ends at step 114.

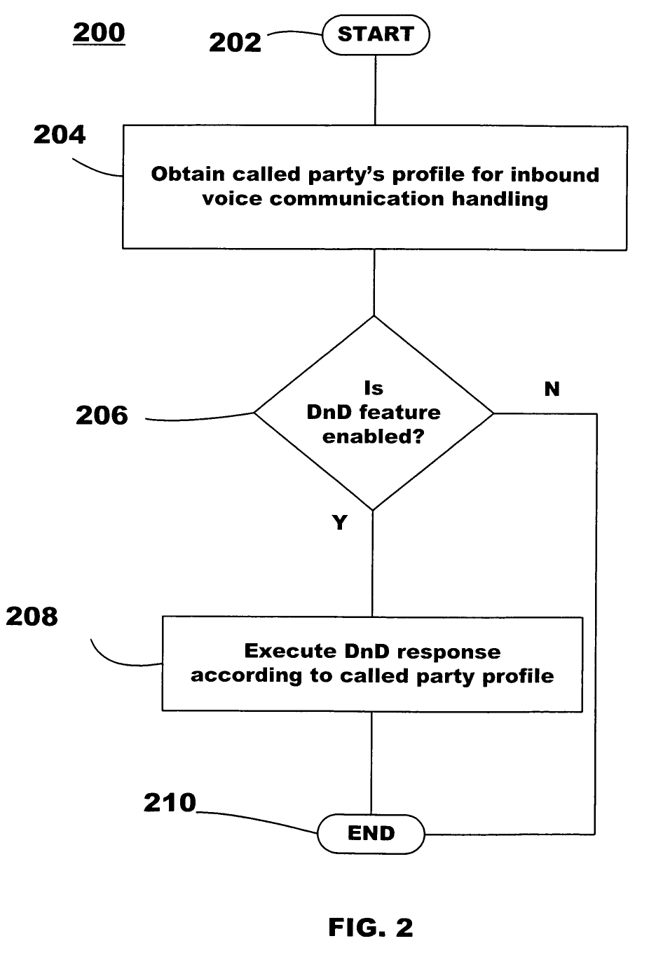

As discussed above, step 104 makes a few assumptions regarding Party B's telecommunication preferences, namely that all incoming calls are to be handled according to enabled call feature (e.g., DnD) policies and procedures. FIG. 2 depicts a series of method steps 200 for performing call feature processing, in particular DnD, that elaborates upon step 104 of the notification method 100. Specifically, the DnD call processing method 200 starts at step 202 and proceeds to step 204. At step 204, a called party's profile (e.g., Party B) for handling an inbound voice communication is obtained. That is, once the incoming voice communication is received (per step 104), the rules and protocols for processing such voice communication must be established to properly handle the voice communication. In one embodiment of the invention, this is accomplished by the inbound voice communication processor acting upon a query for Party B's profile. Party B's profile is one or more settings (either necessary or optional) for voice communication processing including but not limited to port assignments, call forwarding options, DnD options, ring options, calling party's number or identity and the like. In a preferred embodiment of the invention, the profile is an XML file stored on a database easily accessible to the inbound voice communication processor of Party B.

Once the profile is obtained, the call feature processing method 200 proceeds to step 206 where a decision is made as to whether the call feature (DnD) of the called party (e.g., Party B) is enabled or not. This decision is made by examining the called party profile pulled from the query in the previous step. If the call feature (DnD) is not enabled, the method 200 ends at END step 210. Since this action means that the voice communication was sent to the called party, no additional DnD or notification step associated with method 100 is taken; therefore, step 210 is synonymous with END step 114.

If the call feature (DnD) is enabled, the call processing method 200, proceeds to step 208 where call feature actions are executed according to the called party profile settings. A plurality of options are available for processing calls received during a call feature enabled period and such options are selected from the group consisting of an Announcement action, a VoiceMail action and a Forwarding action. In the Announcement action, the calling party is connected to at least one announcement indicating that the called party is not available or has otherwise selected a DnD setting. Under this option, the calling party is not given an opportunity to respond or otherwise leave a message for the called party. In the VoiceMail action, the calling party is connected to at least one announcement indicating that the called party is not available or has otherwise selected a DnD setting; however, the calling party is given an opportunity to respond or otherwise leave a message for the called party. In the Forwarding action, the calling party is connected to a secondary phone number associated with the called party. Other options are possible (known to those skilled in the art but not specifically described in this disclosure) and considered with the scope of the invention. Additionally, DnD is not the only call feature that can be processed according to the call processing method 200. In an alternate embodiment, the call feature being processed is Call Forwarding that forwards a call originally from Party A to Party B to another one of Party B's devices or lines based upon preferences established in the above-described user profile. With such a feature, the method is essentially the same, only step 206 makes a decision as to whether CF is enabled or not and executes a CF response accordingly in step 208. Other call processing features can be similarly handled that do not alert Party B to the receiving of a new call and are considered within the scope of the invention. The CF feature can be selective in nature. This means that certain incoming calls to Party B can automatically invoke the feature (according to Party B's profile). Other triggers for the feature can be time of day or location of Party B.

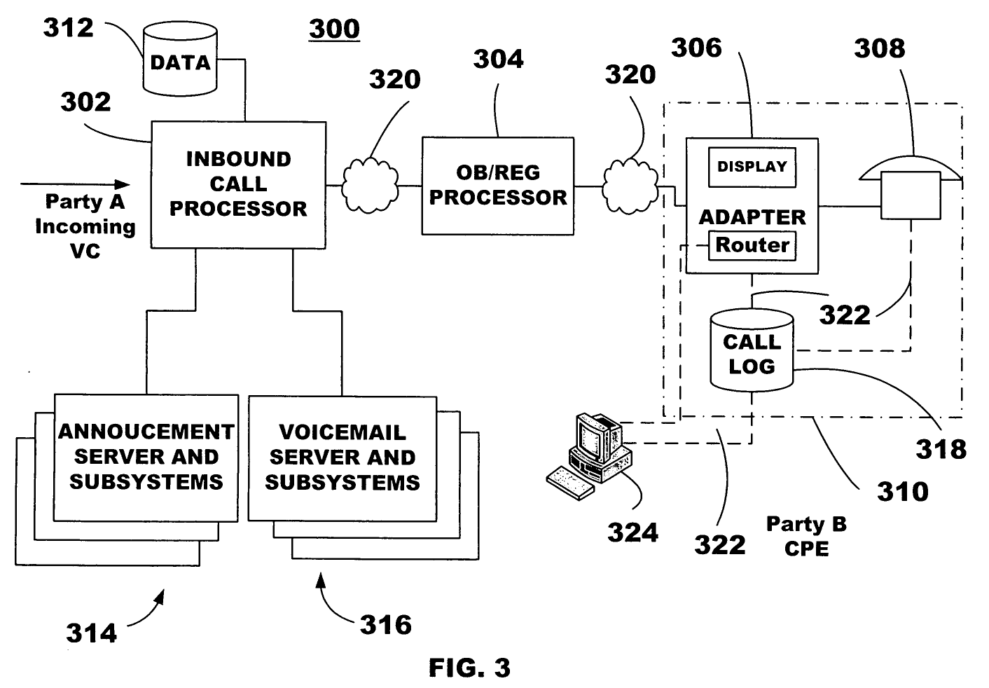

A system for practicing non-delivered call notification in accordance with the subject invention is generally seen in FIG. 3 which depicts a schematic diagram of an exemplary IP-based telecommunication system 300. The system 300 includes an inbound voice communication processor 302 that executes the necessary steps to establish a link between Party A and Party B at Party B's communication device (e.g., a CPE device) as described earlier. Although the inbound voice communication processor 302 is represented as a single network element in FIG. 3, this depiction may also be representative of a plurality of processors capable of performing identical functions as described in this disclosure for the purposes of redundancy in failover conditions of one or more of such processors. In a preferred embodiment of the invention, the inbound voice communication processor 302 is a plurality of processors acting as a proxy group for a given customer account of a VoIP telephony system.

Connected to the inbound voice communication processor 302 is one or more databases/storage devices 312 that contain information regarding a plurality of network users. An example of a suitable database/storage device 312 is a MySQL database on a Linux operating system. The information obtained from the database 312 facilitates voice communication processing functions such as those described earlier. In one embodiment of the invention, the database 312 holds a collection of XML files containing network user profiles and preferences regarding telecommunication services provided thereon.

The system further includes one or more subsystems connected to the inbound voice communication processor 302 to enable various call handling features. For example, for the DnD call handling feature described, an announcement server and subsystem 314 and voicemail server and subsystem 316 are connected to the inbound voice communication processor 302. The announcement server and subsystem 314 provides functionality to the DnD feature when the calling party is not given an option to respond or otherwise leave a message for the called party (i.e., just an announcement is heard by the calling party). The voicemail server and subsystem 316 provides functionality to the DnD feature when the calling party is given an option to respond or otherwise leave a message for the called party. Preferably, there are multiple server subsystems 314/316 to provide robustness, scale and capacity to the system 300 and to allow for different announcements. Such servers and subsystems are well known in the art and in one example is the Asterisk PBX system offered by Digium, Inc. of Huntsville, Ala.

An outbound voice communication/registration processor 304 is connected to the inbound voice communication processor 302 via a public/private data network 320 such as but not limited to the Internet. The outbound voice communication/registration processor 304 conducts various functions for the Party B CPE device including but not limited to maintaining its registration on the communication network and establishing outbound call set up procedures for calls originating from Party B. Although the outbound voice communication/registration processor 304 is represented as a single network element in FIG. 3, this depiction may also be representative of a plurality of processors capable of performing identical functions as described in this disclosure for the purposes of redundancy in failover conditions of one or more of such processors. In a preferred embodiment of the invention, the outbound voice communication/registration processor 304 is a plurality of processors acting as a proxy group for a given customer account of a VoIP telephony system.

Additionally, the outbound voice communication/registration processor 304 serves as an intermediate point for receiving NOTIFY messages as described earlier. Particularly and in one embodiment of the invention, the outbound voice communication/registration processor 304 has a registration state that contains addressing information to enable reading of nomadic or mobile endpoints with addresses that may be dynamic and change with time or as a SIP endpoint changes its physical location.

Connected to the outbound voice communication/registration processor 304 is the CPE device 310 that a called party operates when accessing the communication network 300. The CPE 310 includes an analog telephone adapter ATA 306, a voice communication device 308 and a call log database 318. The ATA 306 is adapted for connection to IP signaling such as but not limited to the outbound voice communication/registration processor 304 or other components of the communication network 300. The ATA 306 has the necessary combination of hardware and software for converting IP signals (e.g., packets) into at least one voice communication. One example of an ATA is modem model no. VT-2442 manufactured and sold by Motorola, Inc. of Schaumburg, Ill. Depending on the available hardware and configuration of the network, one or more voice lines are available at the CPE 310 to allow for different voice communications at the same time. For the purposes of this disclosure and for ease of understanding, only one voice line is described and used for the purposes of the subject invention although multiple lines are possible and can be processed under the DnD (or other) feature(s) as explained.

Connected to the ATA 306 is the voice communication device 308 which is the physical component that the caller actually interfaces with when involved in a voice communication session. In one embodiment of the invention, the voice communication device 308 is selected from the group consisting of an analog telephone, an IP phone (having the ATA integrated therewithin) and a web or “softphone” type of device that operates on a PC with integrated audio transducer devices. One example of a voice communication device 308 that can exploit the advantages of the subject invention is model no. 2500 analog telephone manufactured and sold by Cortelco of Corinth, Miss. Such device is coupled to a separate ATA 306 such as the exemplary device described above. Another example of a voice communication device 308 that can exploit the advantages of the subject invention is model no. UIP1869V IP telephone manufactured and sold by Uniden of Toyko, Japan. Such device incorporates the functionality of the ATA 306 and voice communication device 308 in a single component. Another such communication device 308 is the V-phone manufactured and sold by Vonage of Holmdel, N.J. Such device also incorporates the functionality of the ATA 306 and voice communication device in a single component.

Also connected to the ATA 306 or, in the alternate embodiment, an integrated ATA/voice communication device, is call log database 318. The call log database 318 stores a record of messages received at the ATA 306/integrated device and, most particularly for the purposes of the subject invention, the notification message (e.g., SIP NOTIFY) that is sent from the outbound voice communication/registration processor 304 during execution of a DnD action. The NOTIFY message may also be created, forwarded and stored during execution of a CF action. In one embodiment of the invention, the call log database 318 is a separate and discrete component of the CPE 310; in a second embodiment, call log database 318 is an integrated part of the ATA 306; in a third embodiment, the call log database 318 is a file created and updated on the customer's computer 324. As there are at least three different connection embodiments depicted, each such connection 322 is shown in broken line format to depict an optional connection in the alternate of any other connection dependent upon the type of CPE and customer preferences for the telecommunication service. In a preferred embodiment of the invention, the call log database 318 is capable of storing the last ten (10) NOTIFY messages received as a result of the DnD (or other similar non-delivered call feature) action being performed according the above-described method 100.

In FIG. 3, it was shown that there could be three different embodiments of connection to the call log database depending on the type of device associated with Party B's telephone number. It is also possible that there may be one or more devices in addition to (not just as an alternate to) a single device associated with Party B's telephone number. In this manner, Party B has added flexibility in the means for performing voice communications (i.e., wired, wireless, computer based devices and the like). Accordingly, the invention also includes means for having different physical reactions/events to the call feature(s) enabled for each physical device associated with Party B's telephone number. Such means can be extra profile parameters in the user profile, additional hardware in the system 300 or devices themselves and/or a combination of these means. For example, it is possible for a wireless phone having DnD enabled to be given a basic “notification” as described and softphone client on Party B's computer (a second device associated with the telephone number) to be given an enhanced “notification” which may include additional call data, appended messages or attachments and the like.

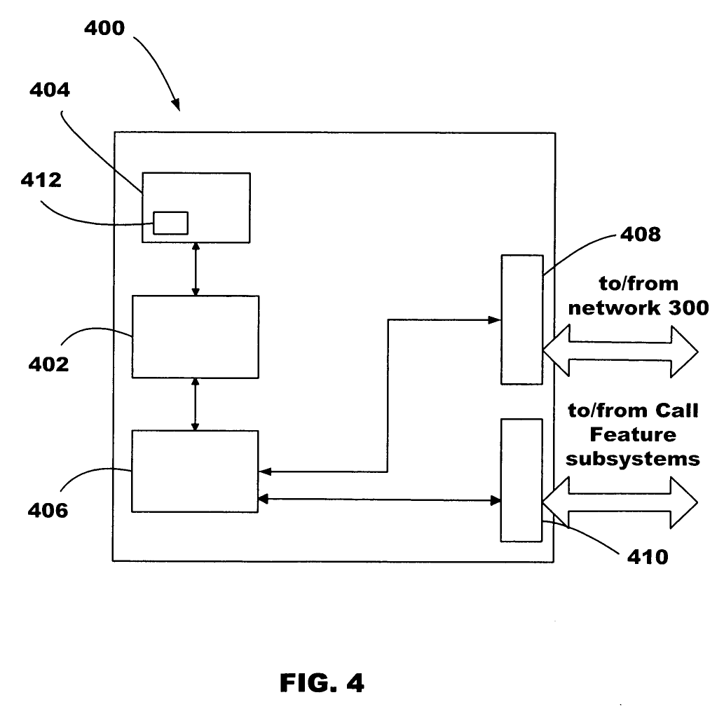

FIG. 4 depicts a schematic diagram of a controller 400 that may be used to practice the present invention. The controller 400 may be used to facilitate DnD (or other similar non-delivered call feature) action and control of the system 300 described above. The controller 400 may be one of any form of a general purpose computer processor used in accessing an IP-based network such as a corporate intranet, the Internet or the like. The controller 400 comprises a central processing unit (CPU) 402, a memory 404, and support circuits 406 for the CPU 402. The controller 400 also includes provisions 408/410 for connecting the controller 400 to the communication network 300 and the one or more call feature processing (i.e., DnD) subsystems 314/316 as described above. Note that the provisions 408/410 are shown as separate bus structures in FIG. 4; however, they may alternately be a single bus structure without degrading or otherwise changing the intended operability of the controller 400 or invention in general. Additionally, the controller 400 and its operating components and programming as described in detail below are shown as a single entity; however, the controller may also be one or more controllers and programming modules interspersed around the system 300 each carrying out a specific or dedicated portion of the DnD (or other similar non-delivered call feature) action as described earlier. By way of non-limiting example, a portion of the controller 400 or software operations may occur at the inbound voice communication processor 302 and another a portion of the controller 400 or software operations may occur at the outbound voice communication/registration processor 304. Other configurations of the controller and controller programming are known and understood by those skilled in the art.

The memory 404 is coupled to the CPU 402. The memory 404, or computer-readable medium, may be one or more of readily available memory such as random access memory (RAM), read only memory (ROM), floppy disk, hard disk, flash memory or any other form of digital storage, local or remote. The support circuits 406 are coupled to the CPU 402 for supporting the processor in a conventional manner. These circuits include cache, power supplies, clock circuits, input/output circuitry and subsystems, and the like. A software routine 412, when executed by the CPU 402, causes the controller 400 to perform processes of the present invention and is generally stored in the memory 404. The software routine 412 may also be stored and/or executed by a second CPU (not shown) that is remotely located from the hardware being controlled by the CPU 402.

The software routine 412 is executed when a preferred method of non-delivery of voice communication is desired. The software routine 412, when executed by the CPU 402, transforms the general purpose computer into a specific purpose computer (controller) 400 that controls the DnD (or other similar non-delivered call feature) actions. Although the process of the present invention is discussed as being implemented as a software routine, some of the method steps that are disclosed therein may be performed in hardware as well as by the software controller. As such, the invention may be implemented in software as executed upon a computer system, in hardware as an application specific integrated circuit or other type of hardware implementation, or a combination of software and hardware. The software routine 412 of the present invention is capable of being executed on computer operating systems including but not limited to Microsoft Windows 98, Microsoft Windows XP, Apple OS X and Linux. Similarly, the software routine 412 of the present invention is capable of being performed using CPU architectures including but not limited to Apple Power PC, Intel x86, Sun SPARC and Intel ARM.

While foregoing is directed to embodiments of the present invention, other and further embodiments of the invention may be devised without departing from the basic scope thereof, and the scope thereof.

What is claimed is:

1. A method of providing notification of an attempted voice communication between a calling party and a called party in a voice communication system comprising the steps of:
the called party receiving a voice communication attempt;
sending a notification of the voice communication attempt to a registration device associated with the called party;
forwarding the notification from the registration device to a terminating point associated with the called party; and
storing the notification at the terminating point associated with the called party.

2. The method of claim 1 wherein the notification occurs as a result of a called party calling feature diverting the voice communication attempt.

3. The method of claim 2 wherein the called party calling feature is selected from the group consisting of Do Not Disturb and Call Forwarding.

4. The method of claim 1 wherein the notification is generated by and sent from a device that is adapted for executing steps to establish a link between a calling party and the called party.

5. The method of claim 4 wherein the device is an inbound voice communication processor of a VoIP communication system.

6. The method of claim 1 wherein the registration device is an outbound/registration communication processor of a VoIP communication system.

7. The method of claim 1 wherein the notification is a Session Initiation Protocol (SIP) message.

8. The method of claim 7 wherein the SIP message is a SIP NOTIFY message.

9. The method of claim 8 wherein the SIP NOTIFY message contains information about the attempted voice communication.

10. The method of claim 1 wherein the terminating point is the called party's logical SIP endpoint.

11. The method of claim 1 wherein the step of storing occurs at a termination point selected from the group consisting of an Analog Telephone Adapter, an IP phone and Local Access Network (LAN) device associated with the called party.

12. The method of claim 1 wherein more than one notification can be stored at the terminating point.

13. The method of claim 1 further comprising the step of reviewing a log of one or more stored notifications.

14. The method of claim 13 wherein the one or more stored notifications can be reviewed in a manner selected from the group consisting of recalling the one or more notifications from a communication device and reviewing the one or more notifications via a web-based interface associated with a called party's communication service account.

15. System for providing notification of an attempted voice communication between a calling party and a called party comprising:
caller communication equipment;
an inbound communication processor connected to the caller communication equipment;
one or more databases connected to the inbound communication processor;
one or more subsystems adapted for calling feature processing connected to the inbound communication processor;
an outbound communication processor connected to the inbound communication processor adapted for receiving notification of an attempted voice communication; and
called party communication equipment connected to the outbound communication processor.

16. The system of claim 15 wherein the notification occurs as a result of a called party calling feature diverting the voice communication attempt.

17. The system of claim 16 wherein the called party calling feature is selected from the group consisting of Do Not Disturb and Call Forwarding.

18. The system of claim 15 wherein the notification is generated by and sent from inbound communication processor.

19. The system of claim 15 wherein the notification is a Session Initiation Protocol (SIP) message.

20. The system of claim 19 wherein the SIP message is a SIP NOTIFY message.

21. The system of claim 20 wherein the SIP NOTIFY message contains information about the attempted voice communication.

22. The system of claim 15 wherein the outbound communication processor serves as an intermediate point for attempted voice communication notifications.

23. The system of claim 15 wherein the called party communication equipment is selected from the group consisting of an Analog Telephone Adapter, an IP phone and Local Access Network (LAN) device associated with the called party.

24. The system of claim 15 wherein more than one notification can be stored at the called party communication equipment.

25. A computer readable medium storing a software program that, when executed by a computer, causes the computer to perform an operation of providing notification of an attempted voice communication between a calling party and a called party in a voice communication system, the operation comprising:
the called party receiving a voice communication attempt;
sending a notification of the voice communication attempt to a registration device associated with the called party;
forwarding the notification from the registration device to a terminating point associated with the called party; and
storing the notification at the terminating point associated with the called party.
